(19) United States
(12) Patent Application Publication
(10) Pub. No.: US 2013/0011711 A1
(43) Pub. Date: Jan. 10, 2013

(54) MODULAR STACKED BATTERY SYSTEM

(75) Inventors: Steven L. Peace, Whitefish, MT (US); Kevin B. Witt, Bigfork, MT (US)

(73) Assignee: ZINC AIR INCORPORATED, Columbia Falls, MT (US)

(21) Appl. No.: 13/177,674

(22) Filed: Jul. 7, 2011

(51) Int. Cl. H01M 4/36; H01M 2/08; H01M 10/04; H01M 2/00

(52) U.S. Cl. 429/101; 429/163; 429/185; 29/623.1; 29/623.2

(57) ABSTRACT

An energy storage cell charged and discharged by electrolyte fluid. The cell includes a module that comprises a wall that separates an anode plate from a cathode plate. An anode hub is connected to the anode plate and a cathode hub is connected to the cathode plate. The anode hub and cathode hub are assembled together through an opening in the wall. An electrical connector connects the anode hub to the cathode hub to electrically connect the anode plate to the cathode plate maintaining the plates on separate sides of the wall at the same electrical potential. A plurality of energy storage cells are connected together to provide a flow cell battery system.

### BACKGROUND

1. Field of the Invention

The present disclosure relates to a segmented electrode for an energy storage system, and a method of making a stacked battery using modular components.

2. Background Art

An energy storage system includes one or more cells that store energy received from a source that charges the cell and releases the energy to a load by discharging the cell. Each cell has an anode and a cathode that an electrolyte flows across. Electrons in the electrolyte are transferred between the cathode and anode to store energy in the system. The system is charged when current is applied to terminals causing electrons to flow from the cathode to the anode. Energy is discharged from the system when a load is applied to the terminals causing electrons to flow from the anode to the cathode.

Patents that were reviewed in conjunction with preparation of this disclosure include U.S. Pat. No. 6,841,047; U.S. Pat. No. 7,261,798; U.S. Pat. No. 7,354,675; and Published Application U.S. 2010/0279558.

### SUMMARY

An energy storage cell module made according to one embodiment of the present disclosure comprises a housing, an anode plate, a cathode plate and an electrical connector operatively connected between the anode hub and the cathode hub. The housing includes at least one separator membrane defining flow passages for the electrolyte. The anode plate includes an anode hub and the cathode plate includes a cathode hub. The anode hub and cathode hub are assembled together with the anode plate and the cathode plate disposed on opposite sides of the separator membrane. An electrical connector connects the anode hub and the cathode hub to conduct electricity between the anode plate and the cathode plate to maintain the plates at the same potential.

An electrode assembly made according to another embodiment of the present disclosure includes a plurality of anode plates and a plurality of cathode plates that are charged and discharged by an electrolyte flowing between paired anode and cathode plates on opposite sides of a membrane separator. Each electrode assembly comprises an anode hub and a cathode hub connected by a canted spring. The anode hub is provided on the anode plate and comprises a first portion of a fitting. The cathode hub is provided on the cathode plate and comprises a second portion of the fitting. The canted spring is partially disposed in a groove formed on one of the first and second portions of the fitting. The canted spring provides an electrical connection between the anode hub and the cathode hub when the first and second portions of the fitting are assembled together.

According to other aspects of the present disclosure, the cathode hub may include a base and a ring that are axially aligned with the ring defining a recess. The anode hub includes a base and a protrusion that are axially aligned. The anode hub and cathode hub may be reversed with the cathode hub having the protrusion and the anode hub having the ring. The protrusion is received in the recess of the cathode hub to assemble the anode hub to the cathode hub. The canted spring may be received in a groove that is formed on the protrusion so that the canted spring contacts the ring when assembled. The ring may have a cylindrical inner wall and the protrusion may have a cylindrical outer wall that fits within the inner wall of the ring.

According to other aspects of the present disclosure, a stacked battery system is disclosed that includes a plurality of modules including a housing wall that is disposed between an anode plate and a cathode plate. The housing wall defines part of the flow path for electrolyte. A first seal is provided on the anode hub to seal between the anode hub and the housing wall and a second seal is provided on the cathode hub to seal between the cathode hub and the housing wall. The first seal may be an O-ring received in a groove formed in a base of the anode hub. The second seal is an O-ring disposed in a groove of a ring portion of the cathode hub. The anode hub and cathode hub are on opposite sides of a split line on the outer surface of the hubs. The first seal is provided on the outer surface of the anode hub and the second seal is provided on the outer surface of the cathode hub. The seals are provided to inhibit the flow of electrolyte into the split line.

A method of making an energy storage cell is also part of the present disclosure. A method of making an energy storage cell comprises attaching an anode hub to an anode plate and a cathode hub to a cathode plate. The anode plate and cathode plate are assembled with the anode hub and the cathode hub being disposed on inwardly facing sides. First and second flow screens are secured between the anode plate and a first membrane separator and between the cathode plate and a second separator membrane. Parallel flow paths are provided on opposite sides of the cell module. A housing wall is provided that defines an opening through which the anode hub and cathode hub are connected. The anode plate of a first cell module is assembled to a first side of the housing wall with the anode hub being inserted into the opening. The cathode plate of a second cell module is assembled to the second side of the housing wall with the cathode hub being inserted into the opening. The cathode hub of the second cell module is connected to the anode hub of the first cell module.

According to other aspects of the method disclosed, a canted spring electrical connector may be partially assembled into a groove on a radially outwardly facing surface of the anode hub. A radially inwardly facing surface of the cathode hub is contacted by the canted spring electrical connector to establish an electrical connection between the anode hub and cathode hub through the canted spring. The anode hub and cathode hub are joined at a split line between a first outer surface of the anode hub and a second outer surface of the cathode hub. The method further comprises assembling a first seal between the first outer surface of the anode hub and the housing and assembling a second seal between the second outer surface of the cathode hub and the housing to inhibit the flow of electrolyte into the split line.

### BRIEF DESCRIPTION OF THE DRAWINGS

FIG. 1 is a diagrammatic view of a modular stacked battery energy storage system;

FIG. 2 is a diagrammatic cross-sectional view of a modular stacked battery system;

FIG. 3 is a fragmentary cross-sectional view of a module of a stacked battery system showing the electrode hub of the stacked battery system;

FIG. 4 is a fragmentary cross-sectional view showing the lower portion of a module of the stacked battery system;

FIG. 5 is a fragmentary cross-sectional view showing the top portion of a module of the stacked battery system;

FIG. 6 is a perspective fragmentary view partially in cross-section showing the middle and lower portion of the module; and

FIG. 7 is a perspective view of a modular stacked battery system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

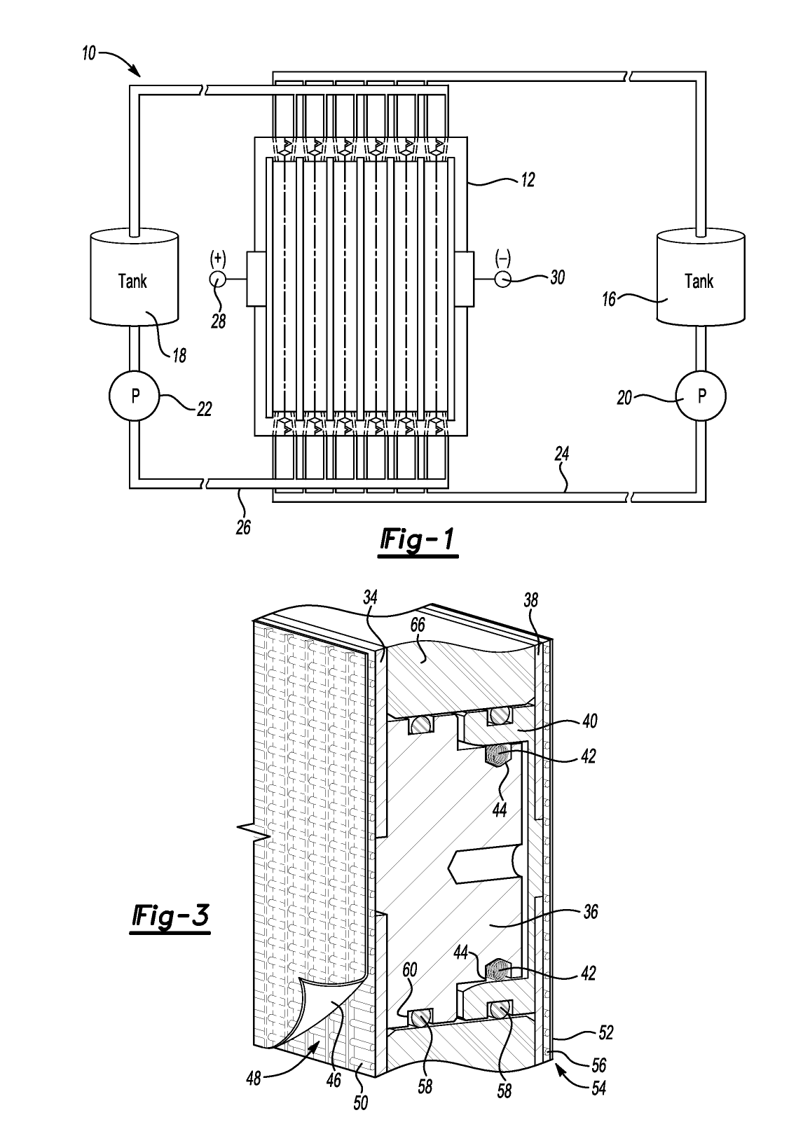

Referring to FIG. 1, a flow cell battery system 10 is shown that includes a modular stacked flow battery 12. An anolyte tank 16 and a catholyte tank 18 store and discharge energy through electrolytic fluids. An anolyte pump 20 and catholyte pump 22 circulate the electrolytic fluids through the battery 12. An anolyte fluid circuit 24 and catholyte fluid circuit 26 comprise piping or tubing that allow the electrolytic fluid to circulate and charge or discharge the system depending upon whether a load or charge is provided to the positive terminal 28 and negative terminal 30.

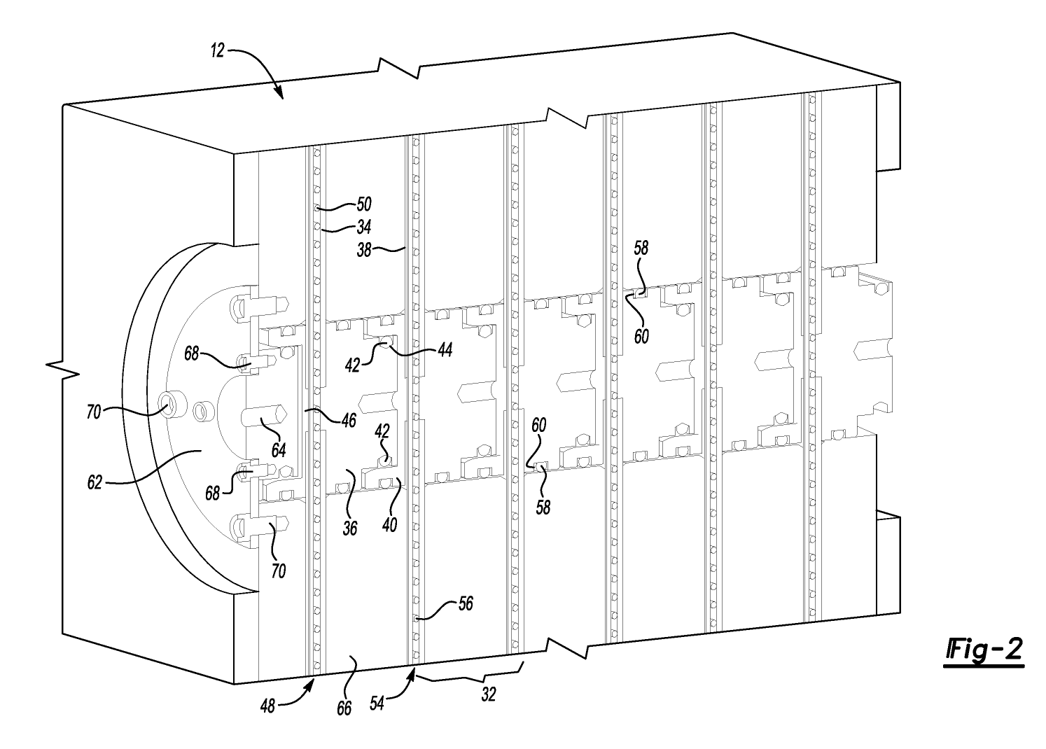

Referring to FIG. 2, a plurality of flow cell modules generally indicated by reference numeral 32 are shown in a fragmentary perspective view. Referring to FIGS. 2 and 3, the structure of the segmented electrode is shown in greater detail. An anode plate 34 is provided that is preferably plated with cadmium and is also welded or otherwise affixed permanently to an anode hub, or boss, 36. A cathode plate 38 is plated with nickel and also connected by welding or other permanent connection to a cathode hub, or boss, 40. The anode hub 36 and cathode hub 40 are assembled together at a split line area which is at the interface of the anode hub 36 and cathode hub 40 and electrically connected by a canted spring electrical contact 42. The canted spring electrical contact 42 is contained within a contact groove 44. Instead of a canted spring electrical contact 42, a radial flat spring contact, or other plug connector could be used to connect the anode hub 36 to the cathode hub 40.

A membrane 46, or separator, is provided to define an anolyte fluid channel 48. An anolyte flow screen 50 is disposed in the anolyte fluid channel 48. The membrane 46 is preferably formed of a material that is impervious to fluid transmission, but allows electrons to flow through the membrane. One example of an appropriate membrane would be Gortex® or other similar PTFE-based membranes. The anolyte flow screen 50 is preferably a screen-like layer that includes a plurality of intersecting rods or strands. The anolyte flow screen 50 functions to mix the anolyte as it flows upwardly through the anolyte fluid channel 48.

A second membrane 52, or separator, is provided on the opposite side of the flow cell module 32 and encloses a catholyte fluid path 54 in which a catholyte flow screen 56 is disposed. The membrane 52 is formed of the same material as the membrane 46. Similarly, the membrane 52 defines the catholyte fluid path 54 through which a catholyte is directed to flow. The catholyte flow screen 56 mixes the catholyte as it flows upwardly through the catholyte fluid path 54. The catholyte flow screen could also be Nickel foam or another form of material that offers a large surface area of Nickel.

O-rings 58 are provided on the outer radial periphery of the anode hub 36 and the cathode hub 40 to provide a seal that prevents fluid from flowing between the anode hub 36 and the cathode hub 40. The O-rings 58 are disposed in an annular groove 60 that is formed in the outer peripheral surface of the anode hub 36 and the cathode hub 40.

Referring to FIG. 2, an end terminal 62 is provided at the cathode end of the stacked battery 12. The end terminal includes a tap 64 that receives a connector, not shown. The end terminal 62 is secured to a support plate 67. Hub fasteners 68 are provided to connect the end terminal 62 to the support plate 67. Housing fasteners 70 connect the support plate 67 to the end housing 69. At the other end of the stacked battery 12 electrical connection is made between the anode hub and an anode hub tap 71. The canted coil 42 electrically connects the anode hubs 36 and the cathode hubs 40.

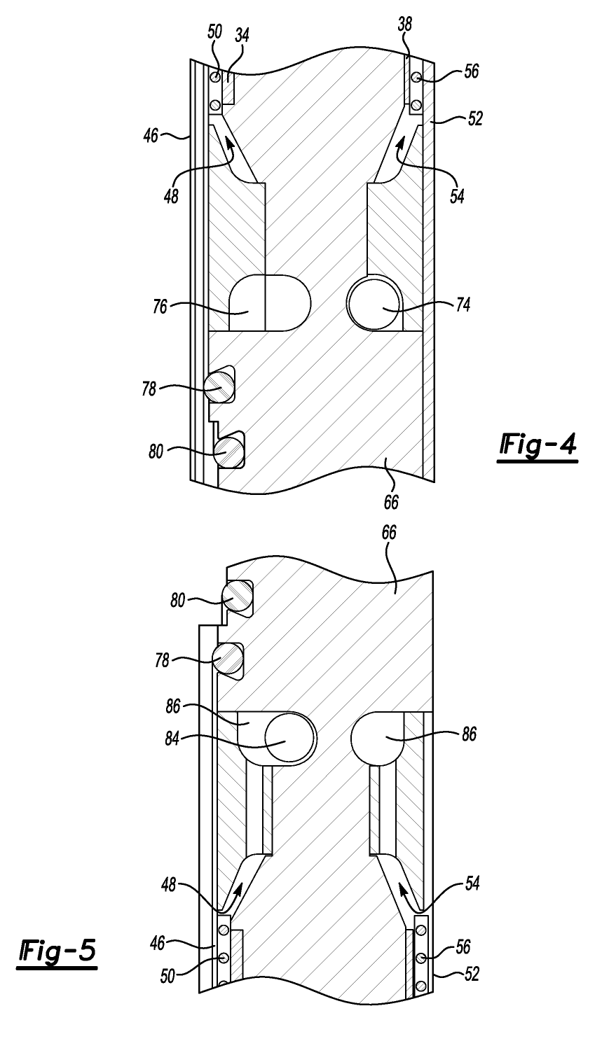

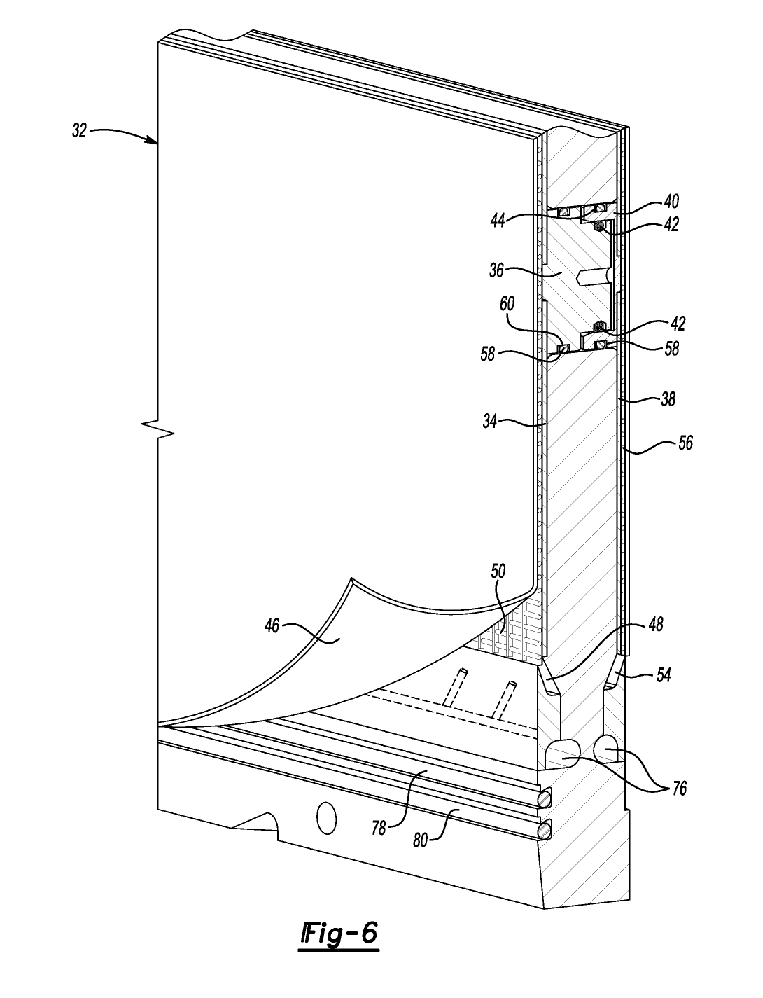

Referring to FIGS. 3-6, fluid flow through the battery 12 is described. A catholyte flow inlet 74 provides the catholyte from the catholyte fluid circuit 26 (shown in FIG. 1) and supplies the catholyte from the lower internal fluid channel 54. An anolyte inlet 76 provides the anolyte from the anolyte fluid circuit 24 to the anolyte fluid channel 48. A membrane seal 78 forms a seal between the membrane 48 and the housing plate 66. An outer seal 80 functions to establish a seal between adjacent housing plates.

An anolyte flow outlet 82 is shown in FIG. 5 that is in fluid flow communication with upper internal flow channels 86 that receive electrolyte fluid from the anolyte fluid channel 48. A catholyte outlet 84 receives catholyte fluid from the catholyte fluid channel 54.

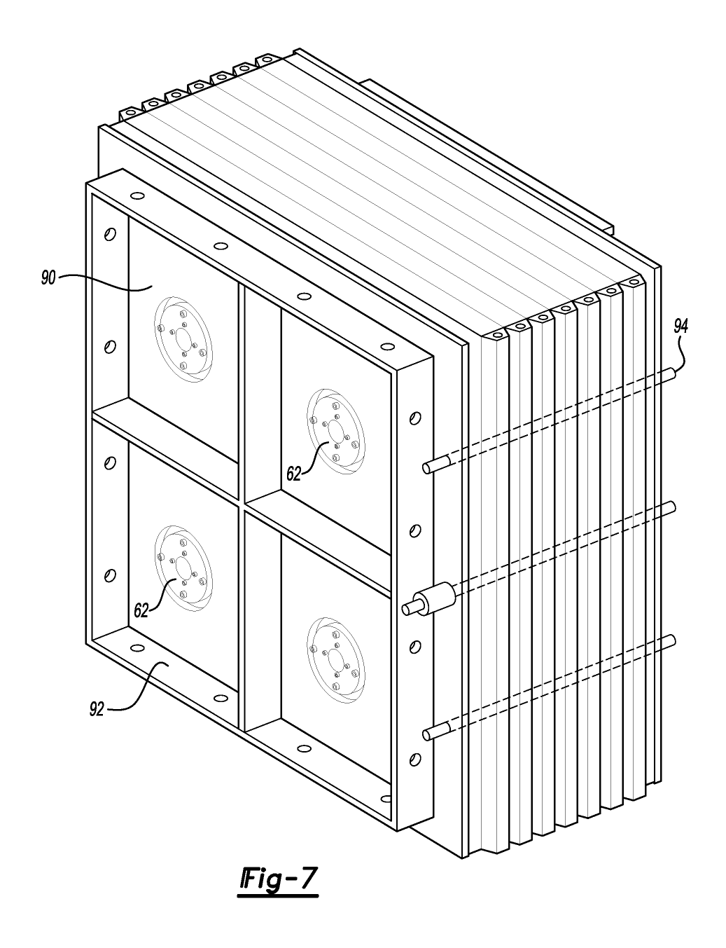

Referring to FIG. 7, a mounting plate 90 and external structural frame 92 are provided to retain the modular stacked flow battery 12 together. The mounting plates 90 and frame 92 are provided on opposite sides of the stacked battery. A plurality of guide rods 94 or other structural connectors connect mounting plates 90 and frame 92 to hold the modular stacked battery together.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A module for an electrical charge storage apparatus that circulates a fluid that charges and discharges the apparatus, the module comprising:
an anode plate assembly including a first anode plate and a separator defining the anolyte fluid passage, the first anode plate having at least one anode pole piece hub; and
a cathode plate assembly including a first cathode plate and the separator defining a catholyte fluid passage, the first cathode plate having at least one cathode pole piece hub that is attached to the anode pole piece hub to conductively connect the anode plate assembly to the cathode plate assembly.

2. The module of claim 1 further comprising a first flow screen disposed in the anodic fluid passage and a second flow screen disposed in the cathodic fluid passage.

3. An energy storage cell that is provided with an electrolyte, the cell comprising:
a housing that includes a plurality of walls that define flow passages for the electrolyte;
a plurality of anode plates that each include an anode hub;
a plurality of cathode plates that each include a cathode hub, wherein the anode hubs and the cathode hubs are assembled together with one of the anode plates and one of the cathode plates being disposed on opposite sides of one of the walls;
a plurality of electrical connectors that are each operatively connected between each of the anode hubs and each of the cathode hubs to electrically connect the anode plate and the cathode plate to maintain paired anode plates and cathode plates at the same potential.

4. The energy storage cell of claim 3 wherein each cathode hub includes a base and a ring that are axially aligned, and the ring defines a recess, and each anode hub includes a base and a protrusion that are axially aligned, and wherein the protrusion is received in the recess to assemble the anode hub to the cathode hub.

5. The energy storage cell of claim 4 wherein the electrical connector is a canted spring that is received in a groove that is formed on the protrusion and wherein the canted spring contacts the ring of the cathode hub.

6. The energy storage cell of claim 4 wherein the ring has a cylindrical inner wall and the protrusion has a cylindrical outer wall, and wherein the outer wall fits within the inner wall.

7. The energy storage cell of claim 3 wherein each wall defines part of the flow path for the electrolyte, and wherein a first seal is provided on the anode hub to seal between the anode hub and the wall and a second seal is provided on the cathode hub to seal between the cathode hub and the wall.

8. The energy storage cell of claim 7 wherein the first seal is an o-ring received in a groove formed in the anode hub and the second seal is an o-ring seal disposed in a groove of the cathode hub.

9. The energy storage cell of claim 7 wherein the anode hub and the cathode hub are joined at a split line between a first outer surface of the anode hub and a second outer surface of the cathode hub, wherein the first seal is provided on the first outer surface of the anode hub and the second seal is provided on the second outer surface of the cathode hub, and wherein the seals inhibit the flow of electrolyte into the split line.

10. An electrode electrical connection assembly for a stacked battery system that includes a plurality of anode plates and a plurality of cathode plates that are charged and discharged by an electrolyte flowing between paired anode plates and cathode plates, wherein each assembly comprises:
an anode hub that is provided on the anode plate, the anode hub having a first portion of a fitting;
a cathode hub that is provided on the cathode plate, the cathode hub having a second portion of the fitting;
a canted spring partially disposed in a groove formed on one of the first and second portions of the fitting, wherein the canted spring provides an electrical connection between the anode hub and the cathode hub when the first and second portions of the fitting are assembled together.

11. The assembly of claim 10 wherein the portion of the fitting of the cathode hub includes a base and a ring that are axially aligned, and the ring defines a recess, and the portion of the fitting of the anode hub includes a base and a protrusion that are axially aligned, and wherein the protrusion is received in the recess to assemble the anode hub to the cathode hub.

12. The assembly of claim 11 wherein the canted spring is received in the groove that is formed on the protrusion and wherein the canted spring contacts the ring.

13. The assembly of claim 11 wherein the ring has a cylindrical inner wall and the protrusion has a cylindrical outer wall, and wherein the outer wall fits within the inner wall.

14. The assembly of claim 10 wherein the stacked battery system further comprises a plurality of housing walls, wherein each housing wall is disposed between one of the anode plates and one of the cathode plates, and wherein the housing wall defines part of the flow path for the electrolyte, and wherein a first seal is provided on the anode hub to seal between the anode hub and one of the housing walls and a second seal is provided on the cathode hub to seal between the cathode hub and the one housing wall.

15. The assembly of claim 10 wherein the first seal is an o-ring received in a groove formed in a base of the anode hub and the second seal is an o-ring seal disposed in a groove of a ring portion of the cathode hub.

16. The assembly of claim 10 wherein the anode hub and the cathode hub are joined at a split line on the outer surfaces of the hubs and the first seal is provided on the outer surface of the anode hub and the second seal is provided on the outer surface of the cathode hub, and wherein the seals inhibit the flow of electrolyte into the split line.

17. The assembly of claim 10 wherein a plurality of the assemblies is provided at spaced locations on each of the anode plates and the cathode plates.

18. The assembly of claim 10 wherein the anode hub is assembled to the anode plate, and the cathode hub is assembled to the cathode plate.

19. The assembly of claim 18 wherein the hubs are welded to their respective plates.

20. A method of making an energy storage cell with a plurality of cell modules, the method comprising:
attaching an anode hub to an anode plate;
attaching a cathode hub to a cathode plate;
selecting a housing wall that defines an opening through the housing;
assembling the anode plate to the cathode plate through the opening in the housing wall with the anode hub and the cathode hub on inwardly facing sides of the anode plate and cathode plate, respectively, and securing the anode hub to the cathode hub
assembling first and second flow screens to outwardly facing sides of the anode plate and the cathode plate;
assembling a separator membrane over each of the first and second flow screens to form a cell module that is assembled to other cell modules to establish first and second flow paths through the flow screens;
assembling the anode plate of a first cell module to a cathode plate of a second cell module.

21. The method of claim 20 further comprising assembling a canted spring electrical connector partially into a groove on a radially outwardly facing surface of the anode hub and contacting a radially inwardly facing surface of the cathode hub to establish an electrical connection between the anode hub and cathode hub through the canted spring.

22. The method of claim 20 wherein the anode hub and the cathode hub are joined at a split line area between a first outer surface of the anode hub and a second outer surface of the cathode hub, the method further comprising: assembling a first seal onto the first outer surface of the anode hub and assembling a second seal onto the second outer surface of the cathode hub to inhibit the leakage of electrolyte into the split line area.
